(19) United States
(12) Patent Application Publication
(10) Pub. No.: US 2002/0129031 A1
(43) Pub. Date: Sep. 12, 2002

(54) Managing relationships between unique concepts in a database

(76) Inventors: Lee Min Lau, Salt Lake City, UT (US); Kate Johnson, Sandy, UT (US); Pam Banning, Portland, OR (US); Shaun C. Shakib, Salt Lake City, UT (US); Elva Knight, Salt Lake City, UT (US); Kent Monson, Pleasant Grove, UT (US); Edward M. Cassin, East Layton, UT (US); Patricia S. Wilson, Henderson, NV (US)

Correspondence Address: WORKMAN NYDEGGER & SEELEY, 1000 EAGLE GATE TOWER, 60 EAST SOUTH TEMPLE, SALT LAKE CITY, UT, 84111, US

(21) Appl. No.: 09/755,976

(22) Filed: Jan. 5, 2001

(51) Int. Cl. G06F 7/00

(52) U.S. Cl. 707/101

(57) ABSTRACT

Systems, methods, and computer program products for managing health data dictionary relationships. The relationships between concepts in the health data dictionary are very complex. The relationship manager searches for relationships, adds new relationships to the health data dictionary, updates existing relationships, discovers missing, duplicated or inappropriate relationships, checks the relationships for completeness and redundancy, and fixes errors in the relationships. The relationship manager ensures that the content of the health data dictionary is more complete and more accurate.

### BACKGROUND OF THE INVENTION

1. The Field of the Invention

The present invention relates to databases and to systems and methods for managing related data in a database. More particularly, the present invention relates to systems and methods for managing relationships between concepts included in a health data dictionary database.

2. Description of Related Art

Computer based patient records (CPRs) are medical histories containing clinical data that can be stored and accessed electronically. Even though CPRs are accessible over computer systems and networks, the medical community is still faced with the problem of processing and evaluating CPRs because the clinical data is often not normalized and the CPRs may have different data formats. While electronically storing data is advantageous, storing data that is not normalized or properly arranged can introduce inconsistencies and incompatibilities that significantly limit the usability of databases storing CPRs.

The difficulties associated with processing and evaluating CPRs begin with the organization and accessibility of the clinical data stored in the CPRs, which is often provided by a variety of different legacy systems, such as laboratory systems, pharmaceutical systems, and hospital information systems. Because the clinical data comes from diverse sources, it is not surprising that the clinical data exists in different formats. International Classification of Diseases (ICD), Systematized Nomenclature of Medicine (SNOMED), Systemized Nomenclature of Pathology (SNOP), commercial systems, and other proprietary formats are examples of systems or formats used when creating and storing medical records such as CPRs. Clinical data or CPRs is often accessed by clinicians, administrators, and researchers, as well as for other reasons including regulatory requirements and statistical studies. Accessing clinical data that is not normalized and is stored in different formats or vocabularies makes the clinical data less usable. For these reasons, accessing clinical data can be a lengthy and unfruitful process.

In order to integrate and normalize the clinical data that is received from various legacy systems and in various vocabularies or formats, a data dictionary is needed to help translate and normalize the clinical data. The data dictionary is effectively a medical database that should have a defined, controlled vocabulary that is able to identify and represent unique items or concepts. The data dictionary should also have a data structure that describes the relationships between concepts such that significant medical descriptions and relationships can be produced. A data dictionary meeting these requirements would be able to translate and normalize medical data regardless of the source of the data and the format of the data.

While the attributes of an ideal data dictionary are identifiable, creating such a dictionary is much more problematic. A significant challenge is developing a vocabulary that is capable of handling both syntactic and semantic constructions. This is particularly important with regard to medical data, which is often expressed in natural language rather than numbers.

An early attempt to develop a data dictionary was through the use of structured text, which is still in use in many systems. Structured text relies on a model that defines the order in which data will appear. For example, a model laboratory result can be expressed as: [patient], [test], [result name], [result value], and [units]. Structured text works relatively well for predictable data, but has significant disadvantages. A system using structured text to store clinical data does not perform any evaluation on the clinical data that is stored. As a result, misspellings and incorrect entries can easily occur. In addition, any application that is designed to effectively access the structured text must be aware of all possible data variations. This limitation is extremely difficult to overcome because the dictionary storing the structured text as well as the applications accessing the structured text must be modified every time new information, such as lab tests or new drugs, are added to the structured text. Structured text systems also have difficulty dealing with complex data, such as microbiology reports, and are not able to handle a controlled and standardized vocabulary that can be shared with other providers.

Another vocabulary used in data dictionaries is ICD, which emphasizes semantics. ICD uses a three digit number for representing the general concept, followed by a two digit number that represents a specific concept. While the ICD vocabulary facilitates data storage and retrieval, ICD is not adequate for representing the clinical information that is stored in data dictionaries and ultimately, in CPRS. For example, ICD cannot effectively represent time, which is a key element in many medical events. ICD also has the disadvantage of using a single code or concept to represent multiple events. For example, the ICD code of 100.89, “Other Leptospiral Infection,” is used for at least three fevers and three infections. For this reason, ICD introduces ambiguity that should be avoided in the context of a data dictionary.

SNOMED is a coding system or nomenclature that attends to both semantics and syntax. In fact, SNOMED III is a complete vocabulary that enables practitioners to describe a great number of concepts found in CPRs. SNOMED can describe anatomical and temporal concepts as well as probabilities. In spite of these strengths, however, SNOMED does not provide a syntax that is capable of reflecting complex relationships. SNOMED is a substantially complete list of terms that does not clarify the relationships that exist among those terms.

The information that is ultimately stored in a CPR extends beyond the medical realm to include information related to areas such as demographics and insurance. This type of information presents problems similar to the problems presented by medical vocabularies because different systems use different representations for a single concept. For example, the name of an insurance carrier can be represented in several different ways by different legacy systems. A properly designed data dictionary, therefore can assist the storage of patient related data by providing a vocabulary for other data in addition to medical data.

As the content of a properly designed data dictionary grows, it becomes increasingly important to ensure that relationships between different concepts are preserved. The complex relationships are extremely important to a data dictionary because the relationships enable the data dictionary to produce and generate meaningful information. The relationships also ensure that data is normalized properly. For example, if the relationship between the concepts of antibiotics and allergies is broken or not included in the data dictionary, then it is possible that an allergic reaction to penicillin will not be properly mapped by the data dictionary. In a data dictionary, there are many complex relationships among the content of the data dictionary. Manually maintaining these relationships is extremely difficult, but necessary act in order to preserve the integrity and accuracy of the data dictionary.

### SUMMARY OF THE INVENTION

These and other problems associated with related art are overcome by the present invention, which is directed towards automating the process of managing relationships existing in a health data dictionary. More specifically, the present invention relates to systems and methods for managing complex relationships between unique concepts in a health data dictionary.

The inadequacies and shortcomings of previous vocabularies are substantially overcome by the 3M® Healthcare Data Dictionary (HDD). In the HDD, each concept or item is uniquely defined and the HDD is able to incorporate other vocabularies such as ICD and SNOMED into the definitions and descriptions of the unique concepts. In addition, the HDD is able to establish complex relationships between different concepts, which permits meaningful medical expressions to be conveyed. The HDD, in addition to providing a vocabulary for medical data, also provides a vocabulary for other types of data such as demographics, insurance data, pharmaceutical data, physical location data, and the like.

The content of the HDD is defined and related by an extremely complex semantic network. The relationships are often defined in relationship tables. It is important to ensure that the relationships are current and accurate. One aspect of the present invention is capable of adding, searching for, and updating existing relationships. Another aspect of the present invention is the ability to provide quality assurance for the relationships. The quality assurance often takes the form of searching for missing, duplicate, or inappropriate relationships. The relationship manager automates the review and edit process of the relationships of the health data dictionary to ensure accuracy and completeness.

Additional features and advantages of the invention will be set forth in the description which follows, and in part will be obvious from the description, or may be learned by the practice of the invention. The features and advantages of the invention may be realized and obtained by means of the instruments and combinations particularly pointed out in the appended claims. These and other features of the present invention will become more fully apparent from the following description and appended claims, or may be learned by the practice of the invention as set forth hereinafter.

### BRIEF DESCRIPTION OF THE DRAWINGS

In order to describe the manner in which the above-recited and other advantages and features of the invention can be obtained, a more particular description of the invention briefly described above will be rendered by reference to specific embodiments thereof which are illustrated in the appended drawings. Understanding that these drawings depict only typical embodiments of the invention and are not therefore to be considered to be limiting of its scope, the invention will be described and explained with additional specificity and detail through the use of the accompanying drawings in which:

FIG. 1 illustrates an exemplary system that provides a suitable operating environment for the present invention;

FIG. 2 is a block diagram illustrating the concepts, rules, and knowledge base within a health data dictionary;

FIG. 3 is a block diagram illustrating how data from legacy systems is translated by a health data dictionary and stored in a data repository; and

FIG. 4 is a block diagram of a relationship manager that interacts with relationships existing between the concepts stored in the health data dictionary.

### DETAILED DESCRIPTION OF THE INVENTION

The present invention relates to systems and methods for translating clinical data and more specifically to managing relationships in a health data dictionary (HDD). The HDD contains concepts, each of which is a unique item or idea. The concepts are grouped according to contexts or domains and are used to translate clinical data. The relationships between the concepts are quite complex and are described in a knowledge base of the HDD. Often, relationship tables are used to describe the relationships. The present invention extends to systems and methods for reviewing, editing, updating, and maintaining the relationships of the HDD.

As used herein, clinical, medical or patient data refers to data that is associated with a patient and can include, but is not limited to, pharmaceutical data, laboratory results, diagnoses, symptoms, insurance data, personal information, demographic data, physical locations, beds, rooms, nursing divisions, facilities, buildings and the like. Generally, clinical data generated by a legacy system is stored in a general repository, which may be on-site or off-site. The general repository can also be specific to a particular facility or source or used by multiple sources. Before the clinical data is stored in the general repository, it is transmitted through an interface engine to the HDD, where it is mapped, matched, and/or translated. Finally, the processed data is committed to the general repository. The HDD allows codes to be stored with the clinical data such that the clinical data can be consistently retrieved. The relationships of the HDD allow meaningful statements to be created that related that equate to the submitted clinical data. More specifically, the relationships allow the concepts of the HDD to be combined to accurately reflect the clinical data submitted by the legacy system. The relationships also permit the clinical data to be normalized and stored in a standard form. The present invention therefore extends to both systems and methods for managing relationships in a health data dictionary. The embodiments of the present invention may comprise a special purpose or general purpose computer including various computer hardware, as discussed in greater detail below.

Embodiments within the scope of the present invention also include computer-readable media for carrying or having computer-executable instructions or data structures stored thereon. Such computer-readable media can be any available media which can be accessed by a general purpose or special purpose computer. By way of example, and not limitation, such computer-readable media can comprise RAM, ROM, EEPROM, CD-ROM or other optical disk storage, magnetic disk storage or other magnetic storage devices, or any other medium which can be used to carry or store desired program code means in the form of computer-executable instructions or data structures and which can be accessed by a general purpose or special purpose computer. When information is transferred or provided over a network or another communications connection (either hardwired, wireless, or a combination of hardwired or wireless) to a computer, the computer properly views the connection as a computer-readable medium. Thus, any such connection is properly termed a computer-readable medium. Combinations of the above should also be included within the scope of computer-readable media. Computer-executable instructions comprise, for example, instructions and data which cause a general purpose computer, special purpose computer, or special purpose processing device to perform a certain function or group of functions.

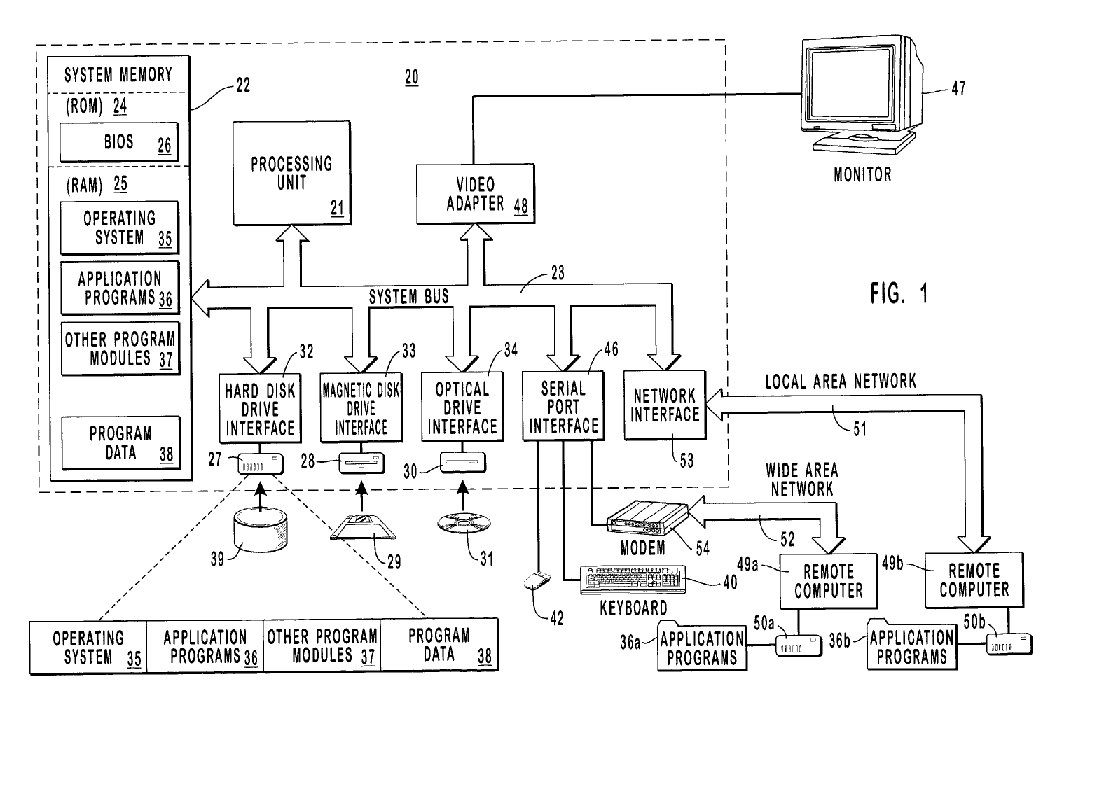

FIG. 1 and the following discussion are intended to provide a brief, general description of a suitable computing environment in which the invention may be implemented. Although not required, the invention will be described in the general context of computer-executable instructions, such as program modules, being executed by computers in network environments. Generally, program modules include routines, programs, objects, components, data structures, etc. that perform particular tasks or implement particular abstract data types. Computer-executable instructions, associated data structures, and program modules represent examples of the program code means for executing steps of the methods disclosed herein. The particular sequence of such executable instructions or associated data structures represent examples of corresponding acts for implementing the functions described in such steps.

Those skilled in the art will appreciate that the invention may be practiced in network computing environments with many types of computer system configurations, including personal computers, hand-held devices, multi-processor systems, microprocessor-based or programmable consumer electronics, network PCs, minicomputers, mainframe computers, and the like. The invention may also be practiced in distributed computing environments where tasks are performed by local and remote processing devices that are linked (either by hardwired links, wireless links, or by a combination of hardwired or wireless links) through a communications network. In a distributed computing environment, program modules may be located in both local and remote memory storage devices.

With reference to FIG. 1, an exemplary system for implementing the invention includes a general purpose computing device in the form of a conventional computer 20, including a processing unit 21, a system memory 22, and a system bus 23 that couples various system components including the system memory 22 to the processing unit 21. The system bus 23 may be any of several types of bus structures including a memory bus or memory controller, a peripheral bus, and a local bus using any of a variety of bus architectures. The system memory includes read only memory (ROM) 24 and random access memory (RAM) 25. A basic input/output system (BIOS) 26, containing the basic routines that help transfer information between elements within the computer 20, such as during start-up, may be stored in ROM 24.

The computer 20 may also include a magnetic hard disk drive 27 for reading from and writing to a magnetic hard disk 39, a magnetic disk drive 28 for reading from or writing to a removable magnetic disk 29, and an optical disk drive 30 for reading from or writing to removable optical disk 31 such as a CD-ROM or other optical media. The magnetic hard disk drive 27, magnetic disk drive 28, and optical disk drive 30 are connected to the system bus 23 by a hard disk drive interface 32, a magnetic disk drive-interface 33, and an optical drive interface 34, respectively. The drives and their associated computer-readable media provide nonvolatile storage of computer-executable instructions, data structures, program modules and other data for the computer 20. Although the exemplary environment described herein employs a magnetic hard disk 39, a removable magnetic disk 29 and a removable optical disk 31, other types of computer readable media for storing data can be used, including magnetic cassettes, flash memory cards, digital versatile disks, Bernoulli cartridges, RAMs, ROMs, and the like.

Program code means comprising one or more program modules may be stored on the hard disk 39, magnetic disk 29, optical disk 31, ROM 24 or RAM 25, including an operating system 35, one or more application programs 36, other program modules 37, and program data 38. A user may enter commands and information into the computer 20 through keyboard 40, pointing device 42, or other input devices (not shown), such as a microphone, joy stick, game pad, satellite dish, scanner, or the like. These and other input devices are often connected to the processing unit 21 through a serial port interface 46 coupled to system bus 23. Alternatively, the input devices may be connected by other interfaces, such as a parallel port, a game port or a universal serial bus (USB). A monitor 47 or another display device is also connected to system bus 23 via an interface, such as video adapter 48. In addition to the monitor, personal computers typically include other peripheral output devices (not shown), such as speakers and printers.

The computer 20 may operate in a networked environment using logical connections to one or more remote computers, such as remote computers 49a and 49b. Remote computers 49a and 49b may each be another personal computer, a server, a router, a network PC, a peer device or other common network node, and typically include many or all of the elements described above relative to the computer 20, although only memory storage devices 50a and 50b and their associated application programs 36a and 36b have been illustrated in FIG. 1. The logical connections depicted in FIG. 1 include a local area network (LAN) 51 and a wide area network (WAN) 52 that are presented here by way of example and not limitation. Such networking environments are commonplace in office-wide or enterprise-wide computer networks, intranets and the Internet.

When used in a LAN networking environment, the computer 20 is connected to the local network 51 through a network interface or adapter 53. When used in a WAN networking environment, the computer 20 may include a modem 54, a wireless link, or other means for establishing communications over the wide area network 52, such as the Internet. The modem 54, which may be internal or external, is connected to the system bus 23 via the serial port interface 46. In a networked environment, program modules depicted relative to the computer 20, or portions thereof, may be stored in the remote memory storage device. It will be appreciated that the network connections shown are exemplary and other means of establishing communications over wide area network 52 may be used.

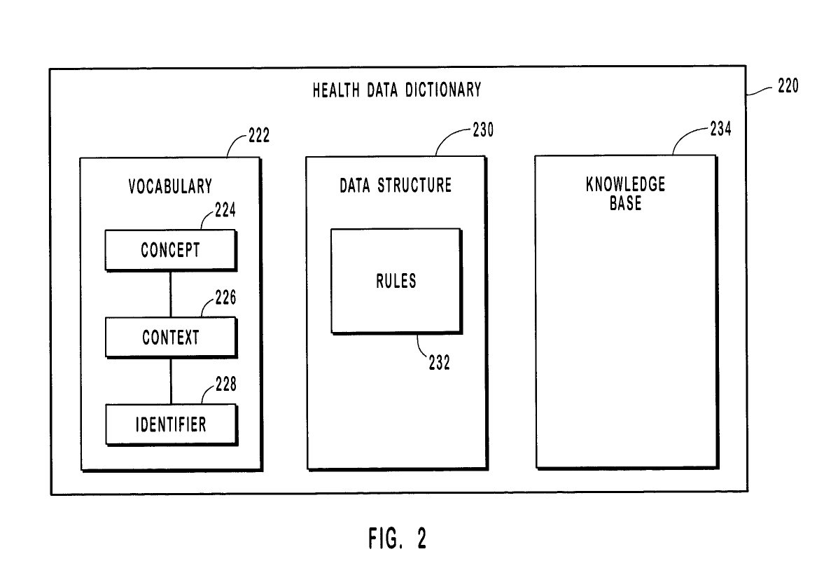

FIG. 2 is a block diagram that illustrates an exemplary health data dictionary (HDD). The HDD 220 describes clinical or medical data in all its possible forms, eliminates data ambiguity, and ensures that data is stored in an appropriate format or vocabulary. The HDD 220 is a database that is used to define or translate the clinical data stored in a computer based patient record (CPR). The HDD 220 ensures that patient data from multiple sources can be integrated and normalized into a form that is accessible by those sources. The HDD 220 integrates a controlled vocabulary, an information model that defines how medical concepts can be combined to produce medical descriptions, and a knowledge base that describes the complex relationships that may exist between the medical concepts.

The vocabulary 222 is designed to identify and uniquely represent concepts. Each concept 224 described within a particular context 226 is assigned a unique identifier 228. For example, the term or concept of “discharge” can occur in several different contexts: A patient can be discharged from a hospital; a surgeon can send a discharge from a wound to a laboratory; a chart can reflect that a discharge from a patient's ears has been occurring for a certain length of time; or a discharge code can be assigned to a particular case. Another example is the concept represented by the term “cold.” Cold can refer to body temperature, a feeling, or an upper respiratory infection.

The ambiguity created by these types of terms can be quickly and easily resolved by a care provider or other person because the context is readily apparent to the care provider. It is much more difficult, however, for computers to resolve these types of problems. The HDD 220 overcomes this problem with the vocabulary 222. The vocabulary 222 includes a concept 224, which is a unique, identifiable item or idea. Using the previous example, “cold” can be a concept. In order to make the cold concept unique, it is often provided in a context 226. As used herein, the combination of context and concept is referred to generally as a concept. If cold refers to an upper respiratory infection, then the context may be, for example, a diagnosis. This type of combination of a concept 224 and a context 226 results in unique identifiable items or ideas and each is assigned an identifier 228. In the HDD 220, duplicate concepts or identifiers 228 are not allowed in order to maintain an accurate, controlled vocabulary 222. The HDD 220 is therefore capable of linking vague, ambiguous representations to precise definitions. The context 226 is often referred to as a domain. Examples of domains include, but are not limited to, insurances, diagnoses, symptoms, lab tests, lab results, and the like.

In essence, the vocabulary 222 links surface forms or representations of concepts as they occur in medical language to unique, unambiguous concepts. For example, the representation of “common cold” and the representation of “URI” can both be related to the cold concept that is defined to be an upper respiratory infections. The vocabulary 222 incorporates many different types of surface forms. For example, synonyms, homonyms, and eponyms are related to concepts in the HDD 220. Different representations of the same concept are related in the HDD 220. Thus, expressing a concept using either natural language or SNOMED will be connected to the same unique concept in the HDD 220. Common variants of a term including acronyms and misspellings are integrated into the vocabulary 222. Foreign language equivalents are included in the vocabulary 222 and specific contexts for certain terms are also reflected in the vocabulary. For instance, “dyspnea” may be a surface form for cardiologists while “shortness of breath” may be the preferred surface form for nursing station personnel.

The HDD 220 uses relationship tables to create these complex relationships. In one embodiment, the HDD 220 simply stores identifiers in the relationship tables, which are used to map or translate data as will be described in more detail below. The surface forms or representations are expressed in tables that effectively map surface forms to specific unique concepts. It is therefore possible for a surface form to be related to more than one concept. In this case, the context is useful in determining which concept is used as previously described.

The data structure 230 is a component of the HDD 220 that provides rules 232 to define how medical concepts are utilized. For example, the isolated concept of cold may be of little value. However, combining the cold concept with other concepts such as other symptoms, can result is a medical description. The concepts which represent symptoms can be combined to describe that a patient feels cold, nauseous, and feverish. In another example, the concepts of chest, x-ray and lung mass can be combined to describe that a chest x-ray shows a lung mass. The rules 232 ensure than meaningful medical descriptions are formed. In other words, concepts such as feverish cannot be combined with an x-ray because an x-ray cannot depict the feverish concept. The rules 232 can be altered as needed to ensure that accurate medical descriptions are obtained from the HDD 220.

The knowledge base 234 of the HDD 220 is used to describe the relationships that exist between the concepts in the HDD 220. For example, a lung mass bay be caused by lung cancer. In one embodiment of the HDD 220, the knowledge base 234 exists as related concept tables that link concepts together in defined relationships. The knowledge base 234 may use “is” and “has the components of” relationships to define the related concept tables. For example, the following table represents an exemplary portion of the knowledge base 234.

| Concept (Context) | Relationship | Concept |
|---|---|---|
| Temperature | Is | Cold |
| | | Hot |
| | | Tepid |
| Illness | Has the components of | Symptoms |
| | | Vital signs |
| | | Diagnosis |

Other types of relationships, such as “is a,” “caused by,” “related to,” “relieved by,” and the like can all be expressed and represented in the knowledge base 234. More generally, the HDD 220 is a collection of relationship tables that define concepts, establish relationships, and provide essential information necessary to translate, map and match clinical data contained in CPRs stored in a data repository. When clinical data has been translated and he unique identifiers describing that data are identified, the unique identifiers are often stored in the data repository such that the process can be reversed.

In order to maintain the integrity of the HDD, each different legacy system, organization, facility, or entity maintains a local copy of the HDD. A master version of the HDD is maintained at a different location and the copy of the HDD can be updated as needed. If necessary, changes made to the copy of the HDD can be uploaded to the master version of the HDD if necessary. In certain circumstances, the local copy of the HDD can the alteration is not made to the master version in order to preserve the integrity of the master version. In addition, many local changes are entity-specific and would have no meaning to other entities. For that reason, these types of changes to the HDD are not propagated. In other words, entities maintain copies of the HDD in part because much of the information maintained by the HDD, such as physical location data, is specific to a user and does not need to be stored in the master version of the HDD. If a particular concept is not found in the HDD, an error message is sent to the master HDD. The error message is reviewed and a new entry may be created in the HDD, depending on the analysis of the error message. If a new entry is created, the local copy of the HDD is updated such that the event that generated the error message no longer occurs.

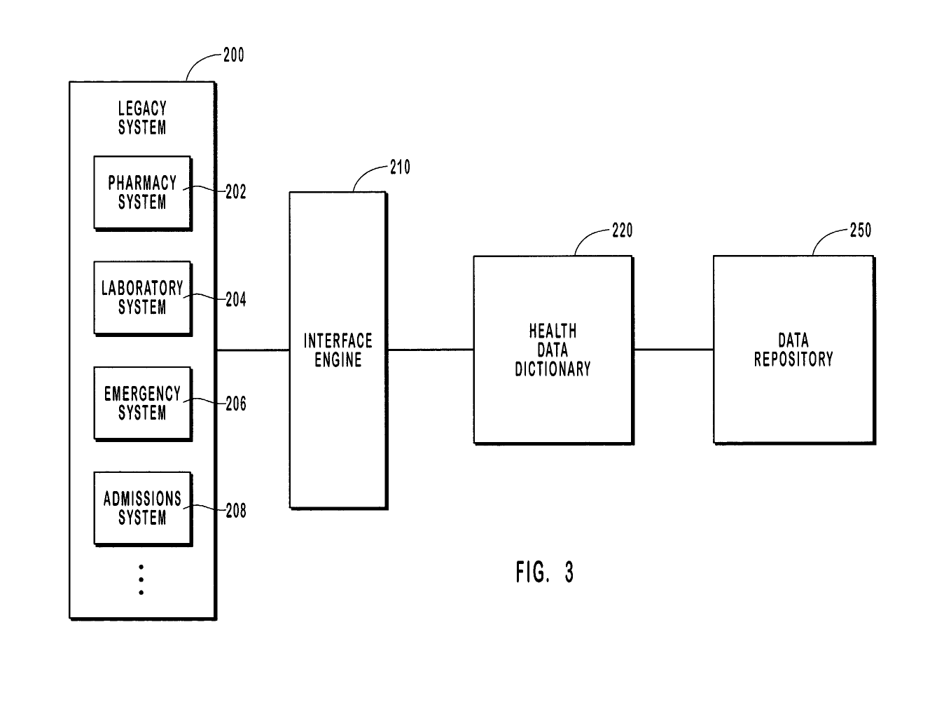

The formation of an extensive computer based patient record (CPR) can potentially involve many different health care providers. Each of these providers obtains different types of information from the patient whose clinical data is stored in the CPR. As previously described, the number of different care providers often causes problems with the CPR because the information gathered by those care providers is in different formats or vocabularies and is not normalized. FIG. 3 is a block diagram that illustrates an exemplary system that uses a health data dictionary to effectively create and store CPRs. The health data dictionary has the significant advantages of providing a data scheme that normalizes patient data and removes ambiguity, returns the patient data to care providers in the appropriate format, and describes medical data in all of its possible forms.

FIG. 3 illustrates a legacy system 200, which is representative of the sources of clinical data including facilities, enterprises, divisions within enterprises, and the like. Exemplary legacy systems include, but are not limited to, pharmacy system 202, laboratory system 204, emergency system 206, and admissions system 208. Each legacy system 200 is used to reflect patient data. The pharmacy system 202, for example, may reflect which drugs have been prescribed for a particular patient as well as the dosage. The laboratory system 204 may describe the results of tests that have been ordered for the patient. The emergency system 206 may reflect the symptoms of a patient as well as a possible diagnosis. The admissions system probably reflects patient data such as name, address, insurance carrier, and the like. In addition, the patient gathered by these legacy systems 200 may overlap in some instances. Other systems may also be used to gather patient information.

Each legacy system transmits data through an interface engine 210. In some instances, the interface engine 210 is not required because the legacy system is a direct client of the HDD. The interface engine 210 generates an interface code that is used when the HDD 220 processes the clinical data provided by the legacy system 200. For example, if the laboratory system 204 is sending data that identifies a patient's blood type from a blood test, then the interface code may be “blood type.” Note that while text is used in this discussion, the actual interface code is most likely a computer recognizable alphanumeric string. The HDD 220 receives the interface code and is aware that the interface engine 210 associated with the laboratory system 204 sent the clinical data. Based on this context, the HDD 220 is able to use the interface code to find the concept identifiers that represent blood type. In this situation, more than one concept may be needed to accurately reflect the clinical data. A separate concept identifier may be needed to identify the test performed by the laboratory, the actual blood type, and the like. These concept identifiers are then stored in the data repository 250 along with information that identifies the patient. In this manner, the data repository 250 contains a patient's CPR in a standard and normalized form that is consistent with other information stored in the data repository 250 for that patient from other clinical data sources. The data repository 250 therefore contains a complete history of medical events associated with a particular person in a form that allows for efficient use by multiple parties. If the test is retrieved from the data repository 250, the HDD 220 can reverse the process to determine that a blood test was performed as well as provide the results of the blood test in the appropriate format or vocabulary. The HDD 220 therefore serves to translate clinical data into a standard and normalized format. Note that the combination of the unique concepts provides a meaningful medical description.

The relationships of the HDD can be quite complex. The following tables are examples of relationship tables that describe or define certain relationships between concepts. The first table is a relationship table for a Logical Observation Identifier Names and Codes (LOINC) that relates the concepts of LOINC identifiers with another concept about a particular laboratory result or test. The second table is a synonym table that describes the relationship between a single concept and different representations of that concept. In these example, text is used in some portions for clarity. Normally alphanumeric identifiers are actually used in the HDD.

TABLE I
Relationship Table for LOINC Code 2159-2

| Concept A | Relationship | Concept B |
|---|---|---|
| LOINC 2159-2 | Has Component | Creatinine |
| LOINC 2159-2 | Has Property | Mass Concentration |
| LOINC 2159-2 | Has Time | Point in Time |
| LOINC 2159-2 | Has System | Amniotic Fluid |
| LOINC 2159-2 | Has Scale | Quantitative |
| LOINC 2159-2 | Has Method | Null Method |

TABLE II
Synonyms for the Component Attribute

| Concept ID | Concept Name | Synonym |
|---|---|---|
| 11 | Metanephrine | METANEPH |
| 11 | Metanephrine | 24H METANEPH |
| 12 | Creatinine Kinase | CK |
| 12 | Creatinine Kinase | CPK |
| 12 | Creatinine Kinase | CK TOTAL |

Table I is an example of the types of relationships that can be used to identify and associate concepts. The examples shown in the “Relationship” column of Table I are only examples of relationships and are not intended as an exclusive listing of possible relationships. In Table II, a single concept is associated with multiple representations. More specifically, concept 11 has a relationship with two synonyms and concept 12 has a relationship with three synonyms. The relationships shown in Table II are often used to map clinical data to the HDD. Tables I and II are intended as illustrations of the relationships that can be included in the HDD and are not an exclusive listing of relationships. In addition, relationships are often identified using these types of relationship tables.

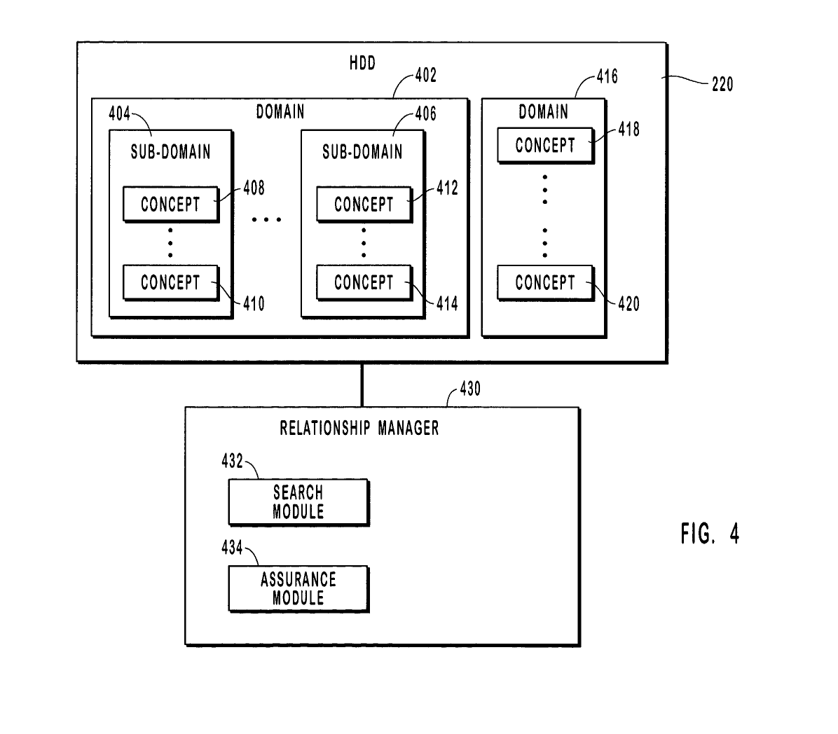

FIG. 4 is a block diagram that illustrates a relationship manager that acts on the relationships stored in the HDD. Before discussing the operation of the relationship manager 430, it is useful to have another view of the content contained in the HDD 220. FIG. 4 illustrates that the concepts of the HDD 220 are arranged in domains and sub-domains. Domain 402, for example is hierarchically related to sub-domain 404 and sub-domain 406. FIG. 4 also illustrates a domain 416. Each domain and sub-domain has concepts that are unique items as previously described. Thus concept 408 is a different idea than concept 410 even though they are in the same domain 402 and sub-domain 404. Each concept is assigned a unique identifier as previously described.

The relationships of the HDD, shown in FIG. 2 as the knowledge base 234, essentially relate concepts. The relationships between concepts can be within the same domain or with concepts in other domains. For example, the concept 410 can be related to the concept 412 and the concept 418 and not related to the concept 414, 408, and 420. The complexity of the relationships is clearly complex and involved.

The relationship manager 430 provides modules that allow the relationships to be maintained, managed, updated, moved, deleted, etc., in order to ensure that the relationships are accurate and complete. The search module 432 provides the ability to search both single and multi-level relationships as well as the ability to search in single or multiple domains.

The assurance module 434 provides the ability to search for relationship errors including, but not limited to, missing relationships, duplicated relationships, and inappropriate relationships. The assurance module 434 also provides for remedying relationship errors. The assurance module 434 allows relationships within a particular sub-domain to be updated, added, or deleted, while checking for redundancies and completeness. The assurance module 434 allows a relationship statement to be inserted to one or more domains and allows for relationship statements to be deleted across one or more domains. The assurance module 434 allows relationship statements to be added, inserted, or updated for a single concept across a single domain or across multiple domains.

For example, one of the entries in the “Concept B” column of Table I could be incorrect. More specifically, assume that water was listed as the system instead of amniotic fluid. Next, the search module 432 could be set to search for relationships related to water. In this case, the search module 432 would identify the relationship shown in Table I. After determining that amniotic fluid should be the system instead of water, the assurance module 434 is used to change the relationship such that the correct system of amniotic fluid is present. The relationship manager 430 may detect circular relationships that are incorrect. In effect, the relationship manager 430 ensures that relationships are current and accurate.

The search module 432 can use input specified by a user as search criteria to find relationships in the relationship tables of the HDD. For example, there may be confusion as to whether a particular substance is a drug or a food. Both the drug and the food can be received orally by a patient. The relationship manager can add relationships that specify whether the substance is a drug or a food in the relationship tables. In this manner, the relationship tables can prevent food from being recognized as drugs and vice versa. Continuing with this example, a relationship may be created in the HDD that indicates that anything ingested orally is a food. This is an example of an inappropriate relationship because not everything that is orally ingested is a food. The relationship manager will search for and identify these types of relationships such that they can be corrected. Examples of correcting the relationships include, but are not limited to adding new relationships, deleting the relationships, and updating the relationships.

The present invention may be embodied in other specific forms without departing from its spirit or essential characteristics. The described embodiments are to be considered in all respects only as illustrative and not restrictive. The scope of the invention is, therefore, indicated by the appended claims rather than by the foregoing description. All changes which come within the meaning and range of equivalency of the claims are to be embraced within their scope.

What is claimed and desired to be secured by United States Letters Patent is:

1. In a system including a health data dictionary, the health data dictionary having content including one or more domains, each domain having one or more concepts, a method for managing relationships between the one or more concepts, the method comprising:
an act of searching the health data dictionary for at least one relationship in the one or more domains, wherein the at least one relationship is associated with the one or more concepts in the domain;
an act of identifying at least one error in the at least one relationship; and
an act of correcting the at least one error in the at least one relationship.

2. A method as defined in claim 1, further comprising an act of updating the at least one relationship.

3. A method as defined in claim 1, further comprising an act of inserting a new relationship in the one or more domains, wherein the new relationship relates at least one concept to at least one other concept.

4. A method as defined in claim 1, further comprising an act of deleting an existing relationship in the domain, wherein the one or more concepts related to the existing relationship is not deleted.[CR1]

5. A method as defined in claim 1, further comprising:
an act of searching for relationships in a hierarchal domain; and
at least one of:
an act of inserting a relationship in a sub-domain;
an act of updating a relationship in the sub-domain; and
an act of deleting a relationship in the sub-domain.

6. A method as defined in claim 1, wherein the act of identifying at least one error further comprises an act of identifying a missing relationship.

7. A method as defined in claim 1, wherein the act of identifying at least one error further comprises an act of identifying a duplicated relationship.

8. A method as defined in claim 1, wherein the act of identifying at least one error further comprises an act of identifying an inappropriate relationship.

9. A method as defined in claim 1, wherein the relationship is described in relationship tables of the health data dictionary.

10. A method as defined in claim 9, further comprising an act of changing the relationship tables to alter existing relationships for the concepts in the health data dictionary.

11. A method as defined in claim 9, further comprising an act of inserting a relationship for a concept in the relationship tables.

12. A computer program product having computer executable instructions for performing the acts recited in claim 1.

13. In a system including a health data dictionary used by legacy systems to map clinical data and store clinical data in a data repository, wherein the health data dictionary has one or more domains, each domain having one or more concepts to map the clinical data, a method for managing relationship tables describing relationships between the one or more concepts, the method comprising:
an act of the relationship manager receiving input to perform an action on at least one relationship within the relationship tables;
an act of searching the relationship tables for the at least one relationship; and
an act of performing the action, wherein results of the action are reflected in the relationship tables.

14. A method as defined in claim 13, wherein the act of receiving input further comprises an act of receiving a search request.

15. A method as defined in claim 13, wherein the act of receiving input further comprises an act of receiving a request to search for errors in the relationship tables.

16. A method as defined in claim 15, wherein the errors include at least on of: a missing relationship; a duplication relationship; and an inappropriate relationship.

17. A method as defined in claim 13, wherein the act of searching the relationship tables further comprises the act of identifying the at least one relationship.

18. A method as defined in claim 13, further comprising an act of updating the at least one relationship.

19. A method as defined in claim 13, further comprising an act of adding a relationship to the relationship tables.

20. A method as defined in claim 13, further comprising an act of deleting a relationship from the relationship tables.

21. A method as defined in claim 13, further comprising an act of fixing the errors in the at least one relationships.

22. A computer program product having computer executable instructions for performing the acts recited in claim 13.

23. In a system including a health data dictionary, wherein the health data dictionary includes one or more concepts included in one or more domains and wherein the health data dictionary maintains relationship tables describing relationships between the one or more concepts, a method for managing the relationships, the method comprising:
a step for searching the relationship tables for one or more relationships;
a step for changing the one or more relationships in the relationship tables, wherein the integrity of the health data dictionary is not compromised; and
a step for committing the changes to the one or more relationships to the relationship tables.

24. A method as defined in claim 23, wherein the step for changing the one or more relationships further comprises a step for finding errors in the relationships.

25. A method as defined in claim 24, wherein the errors include at least one of: a missing relationship; a duplicated relationship; and an inappropriate relationship.

26. A method as defined in claim 24, further comprising a step for fixing the errors in the relationships.

27. A method as defined in claim 23, wherein the step for changing the one or more relationships further comprises a step for updating the one or more relationships.

28. A method as defined in claim 23, wherein the step for changing the one or more relationships further comprises a step for inserting a new relationship in the relationship tables.

29. A method as defined in claim 23, wherein the step for changing the one or more relationships further comprises a step for deleting a relationship from the relationship tables.

30. A method as defined in claim 23, wherein the step for changing the one or more relationships further comprises a step for checking the relationship tables for completeness.

31. A method as defined in claim 23, wherein the step for changing the one or more relationships further comprises a step for checking the relationship tables for redundancies.

32. A method as defined in claim 23, wherein the step for changing the one or more relationships further comprises a step for searching for relationships across the one or more domains.

33. A method as defined in claim 23, wherein the step for committing the changes further comprises a step for ensuring that the integrity of the relationship tables is unaffected.

34. A computer program product having computer executable instructions for performing the steps recited in claim 23.
